(19) United States
(12) Patent Application Publication
(10) Pub. No.: US 2019/0141784 A1
(43) Pub. Date: May 9, 2019

(54) Independent Satellite Wi-Fi Tower

(71) Applicants: Vladimir Smelyansky, Glenview, IL (US); Patricia Mathis, West Palm Beach, FL (US)

(72) Inventors: Vladimir Smelyansky, Glenview, IL (US); Patricia Mathis, West Palm Beach, FL (US)

(21) Appl. No.: 16/184,308

(22) Filed: Nov. 8, 2018

Related U.S. Application Data
(60) Provisional application No. 62/583,256, filed on Nov. 8, 2017.

(51) Int. Cl. H04W 88/08; H04B 7/185; H02J 7/00

(52) U.S. Cl. CPC H04W 88/08; H02J 7/35; H02J 7/0068; H04B 7/18517

(57) ABSTRACT

Embodiments of the present systems and methods may provide Internet connectivity even in situations in which power and communication infrastructure is unavailable. For example, in an embodiment, a communication system may comprise a first communication apparatus adapted to provide wireless communication with a plurality of devices, a second communication apparatus communicatively connected to the first communication apparatus and adapted to provide communication between the first communication apparatus and a satellite communication network, wherein the first communication apparatus is adapted to communicate data between the plurality of devices and the second communication apparatus, and the second communication apparatus is adapted to communicate data between the plurality of devices and the Internet, via the satellite communication network, a rechargeable power supply adapted to supply electrical power to the first communication apparatus and to the second communication apparatus, and a power source adapted to supply electrical power to the rechargeable power supply.

### CROSS-REFERENCE TO RELATED APPLICATIONS

This application claims the benefit of U.S. Provisional Application No. 62/583,256, filed Nov. 8, 2017, the contents of which are incorporated herein in their entirety.

### BACKGROUND

The present invention relates to a portable system for providing Wi-Fi connectivity via satellite to the Internet.

Mobile or portable devices, such as smartphones, tablets, laptop computers, etc. are capable of independent operation for a period of time, for example, without connection to the electrical power grid. The operation time of such devices may be extended indefinitely using portable and/or renewable energy chargers. For example, currently available renewable chargers may be based on solar panels and may be implemented as portable solar charger systems, etc. Thus, such mobile or portable devices may remain operational even if infrastructure, such as the electrical power grid, is offline, damage, or simply unavailable.

However, even if one can power the mobile or portable device, in today's world it does not have much value unless there is an accessible Internet connection. In situations where electrical power infrastructure is not operational, communications infrastructure, such as wireless carrier networks, may also be unavailable. Thus, even though mobile or portable devices may remain operational, the lack of communications infrastructure means that such devices are not useful.

Accordingly, a need arises for techniques that provide Internet connectivity even in situations in which power and communication infrastructure is unavailable.

### SUMMARY

Embodiments of the present systems and methods may provide Internet connectivity even in situations in which power and communication infrastructure is unavailable. Embodiments may include, for example, an independent satellite Wi-Fi system that may provide Wi-Fi connectivity to mobile and portable devices, satellite connectivity to the Internet, and a power source that is independent of infrastructure that may be unavailable.

For example, in an embodiment, a communication system may comprise a first communication apparatus adapted to provide wireless communication with a plurality of devices, a second communication apparatus communicatively connected to the first communication apparatus and adapted to provide communication between the first communication apparatus and a satellite communication network, wherein the first communication apparatus is adapted to communicate data between the plurality of devices and the second communication apparatus, and the second communication apparatus is adapted to communicate data between the plurality of devices and the Internet, via the satellite communication network, a rechargeable power supply adapted to supply electrical power to the first communication apparatus and to the second communication apparatus, and a power source adapted to supply electrical power to the rechargeable power supply.

In embodiments, the first communication apparatus may be adapted to provide wireless communication with a plurality of terrestrial mobile or portable devices. The wireless communication may be data communication. The wireless communication may be a Wi-Fi communication. The power source may comprise a renewable power source. The renewable power source may comprise a solar panel. The renewable power source may comprise a wind turbine.

In an embodiment, a communication system may comprise a wireless router adapted to provide wireless communication with a plurality of wireless devices, a satellite communication system communicatively connected to the wireless router and adapted to provide communication between the wireless router and a satellite communication network, wherein the wireless router is adapted to communicate data between the plurality of devices and the satellite communication system, and the satellite communication system is adapted to communicate data between the plurality of wireless devices and the Internet, via the satellite communication network, a rechargeable power supply adapted to supply electrical power to the first wireless router and to the satellite communication system, and a power source adapted to supply electrical power to the rechargeable power supply.

In embodiments, the wireless router may be adapted to provide wireless communication with a plurality of terrestrial mobile or portable devices. The wireless router may be a Wi-Fi router. The power source may comprise a renewable power source. The renewable power source may comprise a solar panel. The renewable power source may comprise a wind turbine. The system further may comprise a tower and at least one of the wireless router, satellite communication system, and power source is mounted to the tower. The power source may comprise a solar panel.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary system in which the present systems and methods may be implemented.

FIG. 2 illustrates an exemplary physical embodiment of the system shown in FIG. 1.

### DETAILED DESCRIPTION

Embodiments of the present systems and methods may provide Internet connectivity even in situations in which power and communication infrastructure is unavailable. Embodiments may include, for example, an independent satellite Wi-Fi system that may provide Wi-Fi connectivity to mobile and portable devices, satellite connectivity to the Internet, and a power source that is independent of infrastructure that may be unavailable.

Wi-Fi connectivity has become a widespread medium for communications of all types—audio, video, data, etc. Most mobile or portable devices, such as smartphones, tablets, laptop computers, etc., include Wi-Fi communications capability as a standard feature. Accordingly, Wi-Fi communications is used herein as an example of a communications technique that may be used with embodiments of the present systems and methods. However, the present systems and methods are not limited to Wi-Fi communications, but rather may be used with any communications technique.

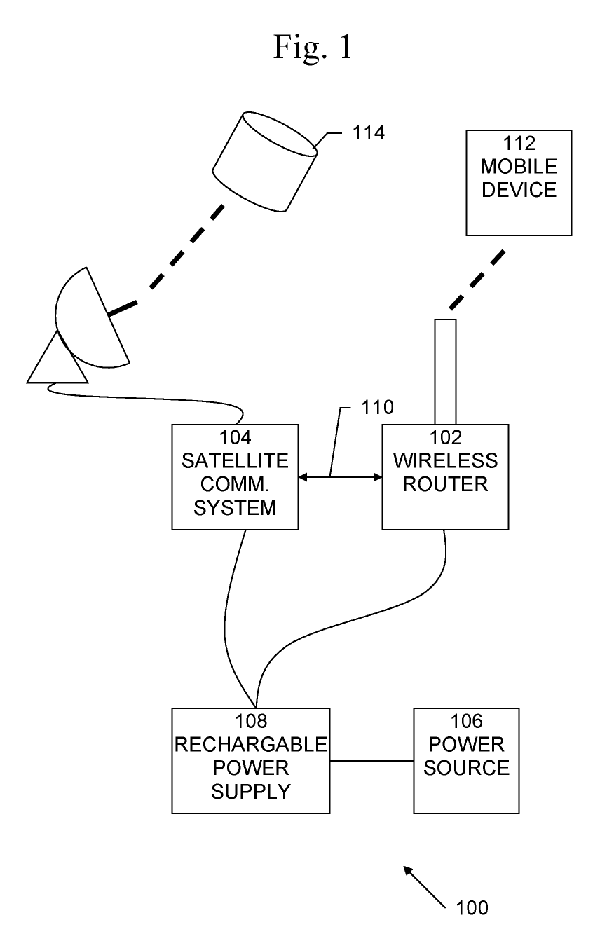

An exemplary system 100 in which the present systems and methods may be implemented is shown in FIG. 1. In this example, system 100 includes wireless router 102, satellite communication system 104, and power source 106, and rechargeable power supply 108. In embodiments, wireless router 102 may include any standard or proprietary device that provides the functions of a network router and a wireless access point. Wireless router 102 may communicate with one or more mobile or portable devices 112 using the wireless access point and using any standard or proprietary wireless communication technique. Wireless router 102 may communicate with satellite communication system 104 using the router function and using any standard or proprietary networking technique 110. Typically, wireless router 102 may communicate with mobile or portable devices 112 using Wi-Fi and with satellite communication system 104 using Ethernet, but any standard or proprietary wireless communication or networking technique may be used.

In embodiments, satellite communication system 104 may include any standard or proprietary device that provides communications with one or more satellite communication networks 114. Although not shown in this example, satellite communication network 114 may provide connectivity with the Internet via a ground station in a location in which power and communication infrastructure is available.

In embodiments, power source 106 may include any standard or proprietary electrical power source. For example, power source 106 may include a renewable power device, such as a solar panel, wind turbine, hydroelectric generator, etc. Likewise, power source 106 may include a non-renewable power device, such as a portable gasoline or diesel generator, a motor vehicle electrical system, etc. In the example shown, power source 106 may supply power to rechargeable power supply 108 and rechargeable power supply 108 may supply power to wireless router 102 and satellite communication system 104. This is particularly advantageous when power source 106 is a renewable power source. For example, if power source 106 includes a solar panel, the power output from power source 106 may vary depending upon the solar illumination, and no power may be supplied at night. Likewise, if power source 106 includes a wind turbine, the power output from power source 106 may vary depending upon the available wind. n embodiments, power source 106 may provide power to operate wireless router 102 and satellite communication system 104 and to charge rechargeable power supply 108 when power output from power source 106 is available, and rechargeable power supply 108 may provide power to operate wireless router 102 and satellite communication system 104 when power output from power source 106 is not available.

In embodiments, power source 106 may directly power wireless router 102 and satellite communication system 104, for example, in situations in which power source 106 includes a non-renewable power device, such as a portable gasoline or diesel generator, a motor vehicle electrical system, etc. However, even in situations in which power source 106 includes a non-renewable power device, in embodiments, power source 106 may supply power to rechargeable power supply 108 and rechargeable power supply 108 may supply power to wireless router 102 and satellite communication system 104. In embodiments, power source 106 may include connection to the electrical power grid, for example, to keep rechargeable power supply 108 charged when not in use. Further, in embodiments, system 100 may be used with connection to the electrical power grid, for use in locations in which the electrical power grid is unreliable, or power is not always available.

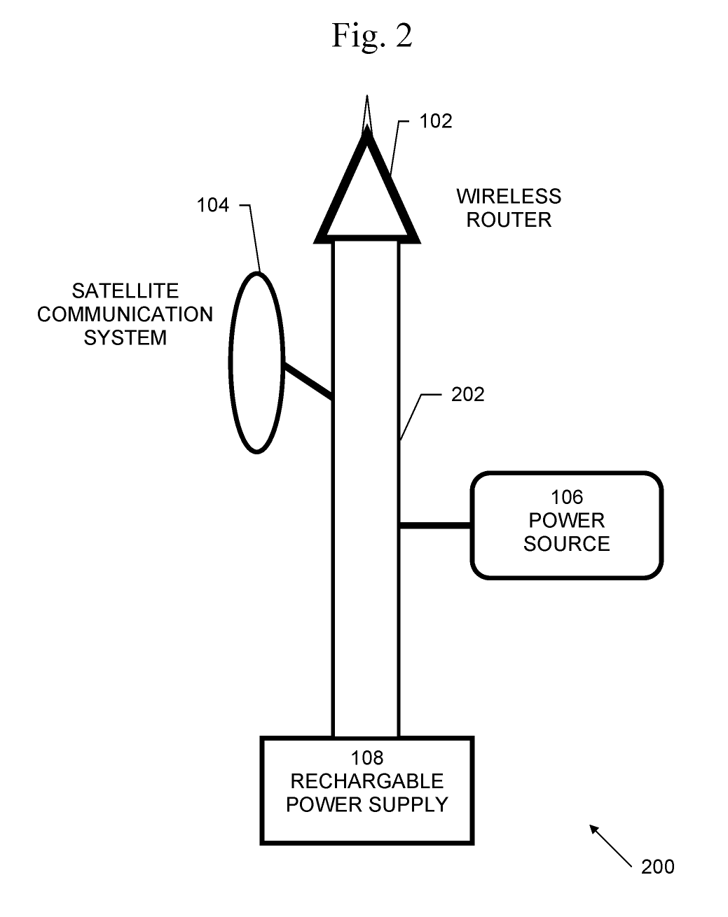

An exemplary physical embodiment of system 100, in which the components of system 100 are assembled to a tower apparatus 200, is shown in FIG. 2. In this example, wireless router 102, satellite communication system 104, and power source 106, and rechargeable power supply 108 may be attached to a pole or tower 202. For example, wireless router 102 may be attached at the top of tower 202, to provide maximum range, satellite communication system 104 may be attached to tower 202 so as to provide adequate communications with one or more satellites, and power source 106, may be attached to tower 202, for example, so as to provide adequate solar illumination to a solar panel. Likewise, rechargeable power supply 108, which may include one or more heavy batteries, may be attached to the base, or included in a base, of tower 202.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A communication system comprising:
a first communication apparatus adapted to provide wireless communication with a plurality of devices;
a second communication apparatus communicatively connected to the first communication apparatus and adapted to provide communication between the first communication apparatus and a satellite communication network;
wherein the first communication apparatus is adapted to communicate data between the plurality of devices and the second communication apparatus, and the second communication apparatus is adapted to communicate data between the plurality of devices and the Internet, via the satellite communication network;
a rechargeable power supply adapted to supply electrical power to the first communication apparatus and to the second communication apparatus; and
a power source adapted to supply electrical power to the rechargeable power supply.

2. The system of claim 1, wherein the first communication apparatus is adapted to provide wireless communication with a plurality of terrestrial mobile or portable devices.

3. The system of claim 1, wherein the wireless communication is data communication.

4. The system of claim 1, wherein the wireless communication is a Wi-Fi communication.

5. The system of claim 1, wherein the power source comprises a renewable power source.

6. The system of claim 5, wherein the renewable power source comprises a solar panel.

7. The system of claim 5, wherein the renewable power source comprises a wind turbine.

8. A communication system comprising:
a wireless router adapted to provide wireless communication with a plurality of wireless devices;
a satellite communication system communicatively connected to the wireless router and adapted to provide communication between the wireless router and a satellite communication network;
wherein the wireless router is adapted to communicate data between the plurality of devices and the satellite communication system, and the satellite communication system is adapted to communicate data between the plurality of wireless devices and the Internet, via the satellite communication network;
a rechargeable power supply adapted to supply electrical power to the first wireless router and to the satellite communication system; and
a power source adapted to supply electrical power to the rechargeable power supply.

9. The system of claim 8, wherein the wireless router is adapted to provide wireless communication with a plurality of terrestrial mobile or portable devices.

10. The system of claim 9, wherein the wireless router is a Wi-Fi router.

11. The system of claim 8, wherein the power source comprises a renewable power source.

12. The system of claim 11, wherein the renewable power source comprises a solar panel.

13. The system of claim 12, wherein the renewable power source comprises a wind turbine.

14. The system of claim 8, wherein the system further comprises a tower and at least one of the wireless router, satellite communication system, and power source is mounted to the tower.

15. The system of claim 14, wherein the power source comprises a solar panel.
